(19) United States
(12) Patent Application Publication
(10) Pub. No.: US 2007/0296205 A1
(43) Pub. Date: Dec. 27, 2007

(54) CONCEALING ADHESIVE SHEET, CONCEALING ADHESIVE SHEET HAVING RELEASE SHEET, DOUBLE SIDED ADHESIVE SHEET, AND DOUBLE SIDED ADHESIVE SHEET HAVING RELEASE SHEET

(75) Inventors: Katsumi MORONUKI, Tokyo (JP); Natsuki TERASHIMA, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignees: OJI PAPER CO., LTD., Tokyo (JP); OJI PACKAGING CO., LTD., Tokyo (JP)

(21) Appl. No.: 11/768,177

(22) Filed: Jun. 25, 2007

(30) Foreign Application Priority Data
Jun. 27, 2006 (JP) 2006-176299
Jun. 27, 2006 (JP) 2006-176300

(51) Int. Cl. B42D 15/00

(52) U.S. Cl. 283/101

(57) ABSTRACT

A concealing adhesive sheet and a concealing adhesive sheet having a release sheet, in which it is easy to write or print on information, the recycle property of paper such as a postcard can be ensured, and the temporary adhesiveness between a concealing sheet and transparent layer is stable, and a double sided adhesive sheet and a double sided adhesive sheet having the release sheet, in which it is easy to write or print on information, the recycle property of paper such as a postcard can be ensured, and the temporary adhesiveness between transparent layers is stable, are provided.

### RELATED APPLICATIONS

This application claims priority to Japanese Patent Application No. 2006-176299, filed Jun. 27, 2006, and Japanese Patent Application No. 2006-176300, filed Jun. 27, 2006, the contents of which are incorporated herein by reference.

### TECHNICAL FIELD

The present invention relates to a concealing adhesive sheet and a concealing adhesive sheet having a release sheet, which conceal personal information described on a sheet of paper such as a postcard.

Also, the present invention relates to a double sided adhesive sheet and a double sided adhesive sheet having a release sheet, which are used when closing, for example, a spread postcard.

### BACKGROUND OF THE INVENTION

In recent years, protection of personal information has become vitally important. Therefore, when mailing a postcard in which personal information is described, a concealing adhesive sheet is generally attached to the part where the personal information is described so that a third person cannot see the personal information.

As a concealing adhesive sheet for attaching to a postcard, Japanese Laid-Open Utility Model Application No. Sho 63-6870, Japanese Laid-Open Utility Model Application No. Sho 63-11863, and Japanese Laid-Open Utility Model Application No. Sho 63-51772, for example, disclose a concealing adhesive sheet which includes a concealing sheet which does not have light transmission properties, a transparent resin layer as a transparent layer, and an adhesive layer in order to attach the transparent resin layer to a postcard, in which the concealing sheet and the transparent resin layer can be peeled from each other and cannot be reattached (this adhesive is refereed to as temporary adhesive). In this case, a temporary adhesive is applied by the dry lamination method or the extruding lamination method.

The concealing adhesive sheet described in Japanese Laid-Open Utility Model Application No. Sho 63-6870, Japanese Laid-Open Utility Model Application No. Sho 63-11863, and Japanese Laid-Open Utility Model Application No. Sho 63-51772, is attached to a postcard using the adhesive layer by the sender so as to conceal personal information described in an information box of the postcard. Also, in the state, the sender sends the postcard to company etc. which requests personal information. On the other hand, the company etc. which receives postcard with the personal information concealed by the concealing adhesive sheet peels the concealing sheet of the concealing adhesive sheet. After peeling the concealing sheet, the personal information can be read through the transparent resin layer and adhesive layer.

Also, in recent years, a spread postcard folding in two etc. is widely used because a large amount of information can be put and personal information etc. can be concealed.

A spread postcard folding in two has a base material for a spread postcard in which personal information etc. is described on a inside surface which is the surface of the inside side when the sender fold the postcard into two, and a double sided adhesive sheet which attaches the inside surfaces of the base material for the spread postcard so as to spread.

As a double-sided adhesive sheet, Japanese Laid-Open Patent Application No. Hei 07-179082 and Japanese Laid-Open Patent Application No. Hei 11-240278, for example, disclose a double sided adhesive sheet has two transparent resin films as transparent layer which can be peeled from each other and can not be reattached (this adhesive is referred to as temporary adhesive), and an adhesive layer on each outside of the transparent resin films. In this case, the temporary adhesive is applied by the dry lamination method or the extruding lamination method.

The spread postcard having the double sided adhesive sheet is closed by using a double sided adhesive sheet on the sender's side and is opened by peeling the transparent resin films of the double sided adhesive sheet at the interface on the receiver's side. In the state where the spread postcard is opened, any personal information etc. described on a base material for spread postcard can be read through the transparent resin film and adhesive layer.

### SUMMARY OF THE INVENTION

Since it is common for a company etc. to add further information or omitted parts to the description of personal information, it is requested to be able to write or print on the description of the personal information.

However, in the concealing adhesive sheet of Japanese Unexamined Utility Model Application, First Publication No. Sho 63-6870, Japanese Unexamined Utility Model Application, First Publication No. Sho 63-11863, and Japanese Unexamined Utility Model Application, First Publication No. Sho 63-51772, the transparent resin layer exposed by peeling the concealing sheet is not suitable to write or print on. Especially, it is not suitable to write or print on with aqueous ink and, for example, it is difficult to print by the ink jet recording method.

Also, in the double sided adhesive sheet of Japanese Unexamined Patent Application, First Publication No. Hei 07-179082 and Japanese Unexamined Patent Application, First Publication No. Hei 11-240278, for this request, a method for conducting a mat treatment or a method for applying inorganic material is previously performed on the surface of a transparent resin film which is exposed when opening a spread postcard.

However, even if a mat treatment or an application of inorganic material is previously conducted on a surface of a transparent resin film, sufficient writing properties or printing properties are not ensured and thus it is not easy to write or print on the described personal information. Especially, it is not suitable to write or print with aqueous ink and, for example, it is difficult to print by the ink jet recording method.

Although a high recycle property is recently requested in view of environmental protection, in the concealing adhesive sheet described in Japanese Unexamined Utility Model Application, First Publication No. Sho 63-6870, Japanese Unexamined Utility Model Application, First Publication No. Sho 63-11863, and Japanese Unexamined Utility Model Application, First Publication No. Sho 63-51772, resin remains on the postcard and thus the recycle property of the postcard is impaired. Also, when using the double sided adhesive sheet of Japanese Unexamined Patent Application, First Publication No. Hei 07-179082 and Japanese Unexamined Patent Application, First Publication No. Hei 11-240278, a transparent resin film remains on a spread postcard and thus the recycle property of the spread postcard is impaired.

Therefore, there is a concern if a paper base material having light transmission properties as a transparent layer is used instead of a transparent resin film, because if a concealing sheet and transparent resin layer, or paper base materials having light transmission properties are attached to each other by the dry laminating method, the peeling force unstable, and it is difficult to obtain the stability of a temporary adhesive between a concealing sheet and transparent resin layer, or between paper base materials having light transmission properties.

In consideration of the above circumstances, an object of the present invention is to provide a concealing adhesive sheet and concealing adhesive sheet having a release sheet, in which it can be easy to write or print on information, the recycle property of paper such as a postcard can be ensured, and the temporary adhesiveness between a concealing sheet and a transparent layer is stable, and a double sided adhesive sheet and a double sided adhesive sheet having a release sheet in which it can be easy to write or print on information, the recycle property of a spread postcard etc. can be ensured, and temporary adhesiveness between transparent layers is stable.

The present invention includes the following structures:

[1] A concealing adhesive sheet including a concealing sheet, a paper base material having light transmission properties, a temporary adhesive layer by which the concealing sheet and the paper base material having light transmission properties can be peeled from each other and cannot be reattached, and an adhesive layer provided on the opposite side of the temporary adhesive layer of the paper base material having light transmission properties, wherein the temporary adhesive layer is formed by a wet laminating method.

[2] A concealing adhesive sheet having a release sheet including the concealing adhesive sheet described in [1], and a release sheet laminated on the adhesive layer of the concealing adhesive sheet.

[3] A double sided adhesive sheet including a temporary adhesive laminated sheet having a pair of paper base materials having light transmission properties and a temporary adhesive layer by which the pair of paper base materials having light transmission properties can be peeled from each other and cannot be reattached, and an adhesive layer provided on both sides of the temporary adhesive laminated sheet, wherein the temporary adhesive layer of the temporary adhesive laminated sheet is formed by a wet laminating method.

[4] A double sided adhesive sheet having a release sheet including the double sided adhesive sheet described in [3], and a release sheet which is laminated on either one side or both sides of the double sided adhesive sheet.

In a concealing adhesive sheet and concealing adhesive sheet having a release sheet of the present invention, it can be easy to write or print on information, and a temporary adhesiveness between a concealing sheet and a paper base material having light transmission properties as a transparent layer is stable.

Also, in a double sided adhesive sheet and a double sided adhesive sheet having a release sheet of the present invention, it can be easy write or print on information, a recycle property of a spread postcard etc. can be ensured, and a temporary adhesiveness between transparent layers is stable.

### BRIEF DESCRIPTION OF DRAWINGS

Some of the features and advantages of the invention have been described, and others will become apparent from the detailed description which follows and from the accompanying drawings, in which:

FIG. 1 is a perspective view of a concealing adhesive sheet according to one embodiment of the present invention,

FIG. 2 is a perspective view of a concealing adhesive sheet having a release sheet according to one embodiment of the present invention,

FIG. 3 is a view showing one method for using a concealing adhesive sheet of the present invention,

FIG. 4 is a perspective view of a double sided adhesive sheet according to one embodiment of the present invention,

FIG. 5 is a perspective view of a double sided adhesive sheet having a release sheet according to one embodiment of the present invention,

FIG. 6 is a view showing one method for using a double sided adhesive sheet of the present invention, and a plan view showing an aspect of a double sided adhesive sheet attaching to a base material for a spread postcard,

FIG. 7 is a view showing one method for using a double sided adhesive sheet of the present invention and a plan view showing an aspect in which the part of a base material for a spread postcard, where a double sided adhesive sheet is not attached, is attached to a double sided adhesive sheet,

FIG. 8 is a view showing one method for using a double sided adhesive sheet of the present invention and a perspective view showing a state where a spread postcard is closed by a double sided adhesive sheet, and

FIG. 9 is a view showing one method for using a double sided adhesive sheet of the present invention and a plan view showing a state where a spread postcard is opened.

### DETAILED DESCRIPTION OF THE INVENTION

The invention summarized above and defined by the enumerated claims may be better understood by referring to the following detailed description, which should be read with reference to the accompanying drawings. This detailed description of particular preferred embodiments, set out below to enable one to build and use particular implementations of the invention, is not intended to limit the enumerated claims, but to serve as particular examples thereof

### (1) Concealing Adhesive Sheet

A concealing adhesive sheet according to one embodiment of the present invention is explained.

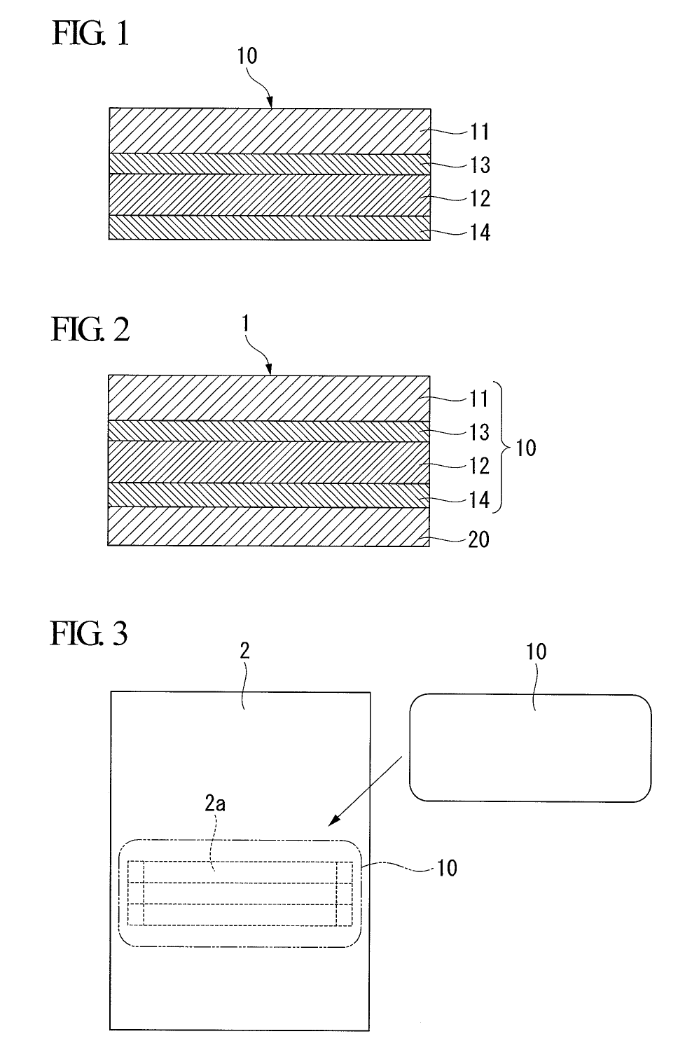

FIG. 1 shows a concealing adhesive sheet according the embodiment. This concealing adhesive sheet 10 includes a concealing sheet 11, a paper base material having light transmission properties 12, a temporary adhesive layer 13 by which the concealing sheet 11 and the paper base material having light transmission properties 12 can be peeled from each other and cannot be reattached, and an adhesive layer 14 provided on the opposite side of the temporary adhesive layer 13 of the paper base material having light transmission properties 12.

Each structure of the concealing adhesive sheet of the embodiment is detailed below.

(1-1) Concealing Sheet

Examples of the concealing sheet 11 include a base material for the concealing sheet on which a predetermined shaped pattern is printed. As a base material for the concealing sheet, paper, film etc. are used.

Examples of paper include a cast-coated paper, an art paper, a coat paper, a wood free paper etc. Examples of plastic film include polyester such as polypropylene, polyethylene, polyethlene terephthalate, and polybutylene terephthalate; various types of polymer film such as polyvinyl chloride; synthetic paper; and the like.

Examples of a print pattern include a solid, stripe, a network, a zigzag, a spot, a character, a design etc.

As the concealing sheet 11, a base material for the concealing sheet 11 in which an opaquer such as titanium oxide is added or applied; a base material for the concealing sheet in which a color film of deep color such as silver, black, and navy blue or color paper of deep color is attached to the entire or the part of the a base material for the concealing sheet; a base material for the concealing sheet to which metal foil such as aluminum foil, or metallized film is attached; and the like may be used.

(1-2) Paper Base Material Having Light Transmission Properties

The paper base material having light transmission properties 12 includes pulp as a main body and has light transmission properties. In the specification, “light transmission properties” indicates visible light transmission properties and means that information described on a postcard etc. is visible through the adhesive layer 14 when attached to a postcard etc. In particular, “light transmission properties” indicates that the haze value is 90% or lower and especially from 30 to 80%.

Particular examples of the paper base material having light transmission properties 12 include a glassine paper, an impregnated paper having 51% by mass or more of pulp content, a paper having low weight per 1 m², a parchment paper, a paper treated by transparent agent etc.

Among particular examples of the paper base material having light transmission properties 12, a glassine paper is preferable in view of the transparency and recycle properties. Among glassine papers, it is preferable to have a density of 0.85 g/m³ or more.

Because a glassine paper having a density of 0.85 g/m³ or more has high hardness, it is hard to break when peeling the concealing sheet 11. Therefore, it is easy to peel the concealing sheet 11.

(1-3) Temporary Adhesive Layer

The temporary adhesive layer 13 is formed by the wet laminating method. In the specification, the wet laminating method indicates a method for laminating two base materials via an adhesive agent which is not completely dried, and attaching the base materials together by conveniently drying the adhesive agent.

The temporary adhesive layer 13 includes various types of temporary adhesive as an adhesive component in which the temporary adhesiveness is obtained and the wet laminating method can be applied.

As temporary adhesive agent, for example, rubber-based adhesives such as a natural rubber and a synthetic rubber; acrylic adhesives containing acrylic acid and/or acrylate ester as a monomer component; vinyl acetate-based adhesive containing vinyl acetate as a main monomer component, such as vinyl acetate polymer and ethylene-vinyl acetate copolymer (EVA); polysaccharide-based adhesives such as starch and sodium alginate; and water-soluble adhesives such as dextrin-based adhesive; may be used.

Among them, rubber-based adhesives, acrylic adhesives, vinyl acetate-based adhesive, and dextrin-based adhesive are preferable, because the adhesiveness can be widely and optionally controlled. In consideration of adhesive strength, a suitable adhesive agent is chosen. Moreover, vinyl acetate-based adhesive and/or dextrin-based adhesive are more preferable, because the wet laminating method can be easily applied.

The content of the temporary adhesive agent in the temporary adhesive layer 13 is preferably from 10 to 100% by mass and more preferably from 20 to 80% by mass because the temporary adhesiveness is sufficiently obtained.

The temporary adhesive layer 13 preferably contains an adhesive force modifier in addition to the temporary adhesive agent. The adhesive force modifiers exert the effect of being dispersed in the temporary adhesive layer 13, thereby to decrease a cohesive force of the temporary adhesive layer 13. By containing an adhesive force modifier in the temporary adhesive 13 to decrease the cohesive force of the temporary adhesive layer 13, it is easy to peel the concealing sheet 11 and the paper base material having light transmission properties 12 from each other.

Examples of the adhesive force modifier include waxes such as polyethylene wax, metal soap, inorganic pigments, organic pigment etc.

The amount of the adhesive force modifier in the temporary adhesive layer 13 is appropriately decided taking account of the adhesive strength between the concealing sheet 11 and the paper base material having light transmission properties 12 as well as the cohesive force of the temporary adhesive layer 13. The amount is preferably from 0 to 90% by mass, more preferably from 5 to 85% by mass, and especially more preferably from 20 to 80% by mass.

The adhesive strength between the concealing sheet 11 and the paper base material having light transmission properties 12 is preferably from 50 to 1000 mN/25 mm (peeling rate: 300 mm/min.), and more preferably from 80 to 600 mN/25 mm (peeling rate: 300 mm/min.) as measured according to a T-type peeling test defined in JIS K 6854-3.

When the adhesive strength as measured according to a T-type peeling test is 50 mN/25 mm or more, the concealing sheet 11 and the paper base material having light transmission properties 12 can be securely attached and also peeled from each other. On the other hand, when the adhesive strength as measured according to a T-type peeling test is 1000 mN/25 mm or less, when peeling the concealing sheet 11 and the paper base material having light transmission properties 12 from each other, the concealing sheet 11 and the paper base material having light transmission properties 12 can be securely peeled from each other, and it is hard to break the concealing sheet 11 and/or the paper base material having light transmission properties 12.

The adhesive strength as measured according to a T-type peeling test can be appropriately controlled by the kind of the temporary adhesive to be used, the permeability, the coating weight, the time required to laminate after coating, and the drying temperature.

The adhesive strength as measured according to a T-type peeling test defined in JIS K 6854-3 can be measured by the following procedure. That is, the sample is allowed to stand under an atmosphere at 23° C. and 50% RH for 24 hours or more and then a peeling test is conducted at a peeling rate of 300 mm/min. by tensile tester etc. The adhesive strength is indicated per test sample width of 25 mm.

(1-4) Adhesive Layer

The adhesive agent included in the adhesive layer 14 is not especially limited and, for example, natural rubber-based adhesive agent, synthetic rubber-based adhesive agent, acrylic-based adhesive agent, urethane-based adhesive agent, silicone-based adhesive agent etc. is used. Any of solvent system, emulsion system, and water system may be used.

Among the adhesive agents, in view of the light transmission properties to visible light, acrylic-based adhesive agent, urethane-based adhesive agent, and silicone-based adhesive agent in solvent system are preferably.

According to need, other assistants may be added to the adhesive agent. Examples of the other assistant include a puffing agent, pH-adjustor, Tackyfire, binder, crosslinker, adhesive particulate, antifoam, antiseptic and mildew-proofing agent, pigment, inorganic filler, stabilizer, wet agent, humectant, etc.

### (2) Concealing Adhesive Sheet Having Release Sheet

Next, the concealing adhesive sheet having a release sheet is explained according to one embodiment of the present invention.

FIG. 2 shows a concealing adhesive sheet having release sheet of the embodiment. This concealing adhesive sheet having release sheet 1 includes a concealing adhesive sheet 10 and a release sheet 20 laminated on an adhesive layer 14 of the concealing adhesive sheet 10.

(2-1) Release Sheet

Examples of the release sheet 20 include a release sheet including a base material for the release sheet and a releasant layer provided on the side of the adhesive layer 14 of the base material for release sheet.

Examples of the base material for the release sheet include paper such as wood free paper, glassine paper etc.; plastic film such as polyethlene terephthalate film, polypropylene film etc; and the like.

Examples of the release agent included in releasant layer include a general silicone-based release agent of an addition system or condensation system; and long chain alkyl group-including compound. Especially, a high reactive silicone-based release agent of addition system is preferably used.

Specific examples of silicone-based release agent include BY24-4527, SD-7220 etc., manufactured by Toray Dow Corning Silicone Co., Ltd; and KS-3600, KS-774, X62-2600 etc., manufactured by Shin-Etsu Chemical Co., Ltd. Also, the silicone-based release agent preferably includes silicone resin of organosilicon compound having SiO₂ unit, (CH₃)₃SiO_{1/2} unit, or CH₂═CH(CH₃)SiO_{1/2} unit. Specific examples of the silicone resin include BY24-843, SD-7292, SHR-1404 etc., manufactured by Toray Dow Corning Toray Silicone Co., Ltd, and KS-3800, X92-183 etc, manufactured by Shin-Etsu Chemical Co., Ltd.

(2-2) Production Method

One example of a production method of the concealing adhesive sheet having the release sheet 1 is explained. In the example of the production method, first, an application liquid for a temporary adhesive is applied on one side of the concealing sheet 11, a part of the moisture is removed according to need, and an application layer is formed to be the temporary adhesive layer 13.

Examples of the application liquid for the temporary adhesive include those in which the temporary adhesive is dissolved or dispersed in water (for example, solution, emulsion, and slurry.) When some types of temporary adhesive are mixed, solution, emulsion, and slurry of a temporary adhesive are mixed to prepare an application liquid for the temporary adhesive. The total solids concentration in an application liquid for the temporary adhesive is preferably from 10 to 70% by mass and more preferably from 20 to 60% by mass. When the total solids concentration in an application liquid for the temporary adhesive is from 10 to 70% by mass, because the permeation from the application liquid to the concealing sheet 11 is small in amount, the release stability of the obtained temporary adhesive layer 13 is higher.

Examples of a method for applying an application liquid for the temporary adhesive include applications using a blade coater, air knife coater, roll coater, bar coater, gravure coater, rod blade coater, lip coater, die coater, curtain coater etc.

The application amount of the application liquid for the temporary adhesive is preferably from 0.5 to 10 g/m² and more preferably from 1 to 5 g/m² in dry amount. When the application amount of the application liquid for the temporary adhesive is 0.5 g/m² or more in dry amount, the obtained temporary adhesive layer 13 has sufficient temporary adhesiveness. When the application amount of the application liquid for the temporary adhesive is 10 g/m² or less in dry amount, it is easy to write or print on personal information etc. after peeling.

Next, after the paper base material having light transmission properties 12 is laminated on the application layer which is to be the temporary adhesive layer 13, water is completely removed by drying according to need, and the temporary adhesive layer 13 is formed. Examples of the drying method include drying by hot air, drying by infrared-ray irradiation etc.

Next, an adhesive agent is applied on the opposite side of the temporary adhesive layer 13 of the paper base material having light transmission properties 12 and dried to provide the adhesive layer 14, and the concealing adhesive sheet 10 is obtained. Then, the release sheet 20 is laminated on the adhesive layer 14 of the concealing adhesive sheet 10 to obtain the concealing adhesive sheet having the release sheet 1.

The concealing adhesive sheet having the release sheet 1 can be produced by methods other than for the above method. For example, the concealing adhesive sheet having the release sheet 1 may be produced by providing the adhesive layer 14 on the release sheet 20, producing a laminate in which the concealing sheet 11 and the paper base material having light transmission properties 12 are attached by the temporary adhesive layer 13, and attaching the adhesive layer 14 provided on the release sheet 20 to the side of the paper base material having light transmission properties 12 of the laminate.

Also, the concealing adhesive sheet having the release sheet 1 may be produced by providing the adhesive layer 14 on the release sheet 20, attaching only the paper base material having light transmission properties 12 to the adhesive layer 14, then applying an application liquid for temporary adhesive on the paper base material having light transmission properties 12 to form an application layer which is to be the temporary adhesive layer 13, attaching the concealing sheet 11 to the application layer, and drying the application layer to form the temporary adhesive layer 13.

(2-3) Method for Using

The concealing adhesive sheet having the release sheet is specifically used as follows.

The release sheet 20 of the concealing adhesive sheet having release sheet 1 is peeled from the adhesive layer 14 to expose the adhesive layer 14 (see FIG. 1). By the exposed adhesive layer 14, as shown in FIG. 3, the concealing adhesive sheet 10 is attached so as to cover a part 2a of the postcard 2 where the personal information is described. In the state where the personal information is concealed, the postcard 2 is mailed to a company etc. requesting the personal information. On the other hand, the company etc., which receives the postcard 2 having the personal information concealed by the concealing adhesive sheet 10, peels the concealing sheet 11 of the concealing adhesive sheet 10. Then, the personal information described in the postcard 2 is read through the paper base material having light transmission properties 12 and the adhesive layer 14. According to need, writing or printing is conducted on the described personal information.

After peeling the concealing sheet 11, although the temporary adhesive layer which is split at the inside remains on the paper base material having light transmission properties 12, the temporary adhesive layer remaining on the paper base material having light transmission properties 12 is generally thin and thus hardly has any influence on writing or printing on the described personal information etc.

According to the concealing adhesive sheet having the release sheet 1 of the above embodiment, because the paper base material is exposed by peeling the concealing sheet 11, it is easy to write or print on. Especially, it is possible to write or print with aqueous ink and it is easy to print by an ink jet recording method. Because the paper base material remains on paper such as a postcard, the recycle properties can be ensured. Moreover, because of the paper base material, the breaking property by hand is excellent and thus it is easy to break by hand and dispose.

Also, because the concealing sheet 11 and the paper base material having light transmission properties 12 are attached by the temporary adhesive layer 13 and the concealing sheet 11 cannot be reattached after peeling, if a third person peels the concealing sheet 11, the evidence thereof remains. Therefore, the fact that the personal information is not seen by a third person can be confirmed by the concealing sheet 11 remaining attached. Also, it is possible to inhibit a third person from unfair peeling of the concealing sheet 11.

The temporary adhesive layer 13 is formed by the wet laminating method and thus has a stable temporary adhesiveness. Therefore, the release power is stable when peeling the concealing sheet 11. That is, when peeling the concealing sheet 11, the temporary adhesive layer 13 is split at the inside and the adhesiveness of the temporary adhesive layer 13 between the concealing sheet 11 and the paper base material having light transmission properties 12 hardly has any influence on the release power of the concealing sheet 11.

### (3) Double Sided Adhesive Sheet

A double sided adhesive sheet is explained according to one embodiment of the present invention.

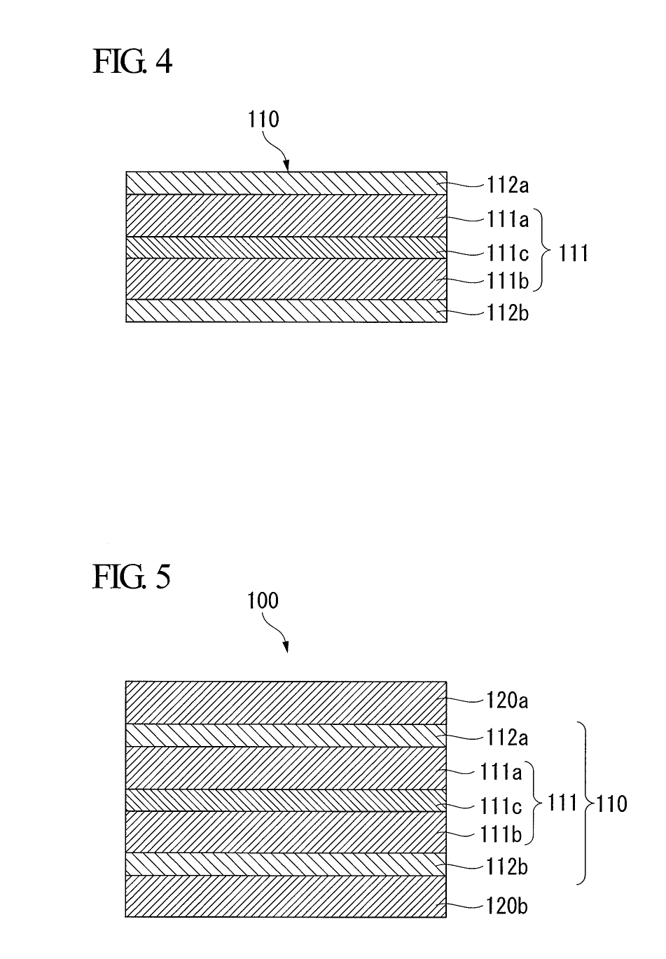

FIG. 4 shows the double sided adhesive sheet of the embodiment. This double sided adhesive sheet 110 includes a temporary adhesive laminated sheet 111, and a first adhesive layer 112a and a second adhesive layer 112b, which are provided on both sides of the temporary adhesive laminated sheet 111.

Each structure of the double sided adhesive sheet of the embodiment is detailed below.

(3-1) Temporary Adhesive Laminated Sheet

The temporary adhesive laminated sheet 111 includes a first paper base material having light transmission properties 111a, a second paper base material having light transmission properties 111b, and a temporary adhesive layer 111c by which the first paper base material having light transmission properties 111a and the second paper base material having light transmission properties 111b can be peeled from each other and cannot be reattached.

(3-1-1) Paper Base Material Having Light Transmission Properties

The first paper base material having light transmission properties 111a and the second paper base material having light transmission properties 111b included in the temporary adhesive laminated sheet 111 include pulp as a main body and have light transmission properties.

In the specification, “light transmission properties” indicates visible light transmission properties and means that information described on a spread postcard is visible. In particular, “light transmission properties” indicates that the haze value is 90% or lower and especially from 30 to 80%.

Specific examples of the first paper base material having light transmission properties 111a and the second paper base material having light transmission properties 111b include the same as those described for the base material having light transmission properties 12.

The first paper base material having light transmission properties 111a and the second paper base material having light transmission properties 111b may be the same or different.

(3-1-2) Temporary Adhesive Layer

As the temporary adhesive layer 111c, the same as those described for the temporary adhesive layer 13 are used.

Also, the temporary adhesive layer 111c preferably contains an adhesive force modifier in addition to the temporary adhesive agent, just like the temporary adhesive layer 13. Adhesive force modifiers exert the effect of being dispersed in the temporary adhesive layer 111c, thereby to decrease a cohesive force of the temporary adhesive layer 111c. By containing an adhesive force modifier in the temporary adhesive 111c to decrease the cohesive force of the temporary adhesive layer 111c, it is easy to peel the first paper base material having light transmission properties 111a and the second paper base material having light transmission properties 111b from each other.

Examples of the adhesive force modifier include waxes such as polyethylene wax, metal soap, inorganic pigments, organic pigment etc.

The amount of the adhesive force modifier in the temporary adhesive layer 111c is appropriately decided taking account the adhesive strength between the first paper base material having light transmission properties 111a and the second paper base material having light transmission properties 111b as well as the cohesive force of the temporary adhesive layer 111c. The amount is preferably from 0 to 90% by mass, more preferably from 5 to 85% by mass, and especially more preferably from 20 to 80% by mass.

The adhesive strength between the first paper base material having light transmission properties 111a and the second paper base material having light transmission properties 111b in the temporary adhesive layer 111c is the same as that between the concealing sheet 11 and the base material having light transmission properties 12 in the temporary adhesive layer 13.

When the adhesive strength as measured according to a T-type peeling test is 50 mN/25 mm or more, the first paper base material having light transmission properties 111a and the second paper base material having light transmission properties 111b can be securely attached and also peeled from each other. On the other hand, when the adhesive strength as measured according to a T-type peeling test is 1000 mN/25 mm or less, when peeling the first paper base material having light transmission properties 111a and the second paper base material having light transmission properties 111b from each other, the first paper base material having light transmission properties 111a and the second paper base material having light transmission properties 111b can be securely peeled from each other, and it is hard to break the first paper base material having light transmission properties 111a and/or the second paper base material having light transmission properties 111b.

The adhesive strength as measured according to a T-type peeling test can be appropriately controlled by the kind of the temporary adhesive to be used, the permeability, the coating weight, the time required to laminate after coating, and the drying temperature.

(3-2) Adhesive Layer

In the adhesive agents included in the first adhesive layer 112a and the second adhesive layer 112b, the same as those included in the adhesive layer 14 may be used.

The first adhesive layer 112a and the second adhesive layer 112b may be the same or different.

### (4) Double Sided Adhesive Sheet Having Release Sheet

The double sided adhesive sheet having the release sheet is described according to one embodiment of the present invention.

FIG. 5 shows the double sided adhesive sheet having the release sheet of the embodiment. This double sided adhesive sheet having the release sheet 100 includes a double sided adhesive sheet 110, a first release sheet 120a laminated on the first adhesive layer 112a of the double sided adhesive sheet 110, and a second release sheet 120b laminated on the second adhesive layer 112b of the double sided adhesive sheet 110.

(4-1) Release Sheet

Examples of the first release sheet 120a and the second release sheet 120b include those having a base material for the release sheet and a releasant layer provided on the side of the first adhesive layer 112a or the second adhesive layer 112b of the base material for the release sheet.

As the base material for the release sheet, those described for the base material for the release sheet of the release sheet 20 can be used.

As the release agent included in the releasant layer, those described for the above release agent included in the releasant layer of the release sheet 20 can be used.

The first release sheet 120a and the second release sheet 120b may be the same or different.

(4-2) Production Method

One example of a production method of the double sided adhesive sheet having the release sheet 100 is explained.

In the example of the production method, first, an application liquid for temporary adhesive is applied on one side of the first paper base material having light transmission properties 111a, a part of moisture is removed according to need, and then an application layer is formed to be the temporary adhesive layer 111c.

As the application liquid for temporary adhesive, the same as those used for the application liquid for temporary adhesive applied on the one side of the concealing sheet 11 can be used. When the total solids concentration in the application liquid for temporary adhesive is from 10 to 70% by mass, because the permeation from the application liquid to the first paper base material having light transmission properties 111a is small in amount, the release stability of the obtained temporary adhesive layer 111c is higher.

As the method for applying the application liquid for temporary adhesive, the same method as those described for applying the application liquid for temporary adhesive to the one side of the concealing sheet 11 can be used.

The application amount of the application liquid for temporary adhesive is preferably from 0.5 to 10 g/m² and more preferably from 1 to 5 g/m² in dry amount. When the application amount of the application liquid for temporary adhesive is 0.5 g/m² or more in dry amount, the obtained temporary adhesive layer 111c has sufficient temporary adhesiveness. When the application amount of the application liquid for temporary adhesive is 10 g/m² or less in dry amount, it is easy to write or print on personal information etc. after peeling.

Next, after the second paper base material having light transmission properties 111b is laminated on the application layer which is to be the temporary adhesive layer 111c, water is completely removed by drying according to need, and the temporary adhesive layer 111c is formed to obtain the temporary adhesive laminated sheet 111. Examples of the drying method include drying by hot air, drying by infrared-ray irradiation etc.

Next, the adhesive agent is applied on both sides of the temporary adhesive laminated sheet 111 and dried to provide the first adhesive layer 112a and the second adhesive layer 112b, and then the double sided adhesive sheet 110 is obtained. The first release sheet 120a is laminated on the first adhesive layer 112a of the double sided adhesive sheet 110 and the second release sheet 120b is laminated on the second adhesive layer 112b of the double sided adhesive sheet 110 to obtain the double sided adhesive sheet having the release sheet 100.

The double sided adhesive sheet having the release sheet 100 can be produced by methods other than the above method.

In examples of other methods for producing the double sided adhesive sheet having release sheet 100, first, the second adhesive layer 112b is provided on the second release sheet 120b and the second paper base material having light transmission properties 111b is attached to the second adhesive layer 112b. Next, the application liquid for temporary adhesive is applied on the second paper base material having light transmission properties 111b to form an application layer which is to be the temporary adhesive layer 111c and, after attaching the first paper base material having light transmission properties 111a to the application layer, the application layer is dried to form the temporary adhesive layer 111c. Then, the first adhesive layer 112a and the first release sheet 120a are provided on the first paper base material having light transmission properties 111a in series to produce the double sided adhesive sheet having the release sheet 100.

Also, the double sided adhesive sheet having the release sheet 100 may be produced by producing an adhesive sheet in which the first adhesive layer 112a is provided on the first release sheet 120a and an adhesive sheet in which the second adhesive layer 112b is provided on the second release sheet 120b and attaching the adhesive sheets to both sides of the temporary adhesive laminated sheet 111 by the first adhesive layer 112a or the second adhesive layer 112b.

(4-3) Method for Using

One example of a method for using the above double sided adhesive sheet having the release sheet 100 is explained. In this example of use, a spread postcard folding in two is produced in which a base material for the spread postcard is closed by the double sided adhesive sheet having release sheet 100 in the state of being temporarily adhered.

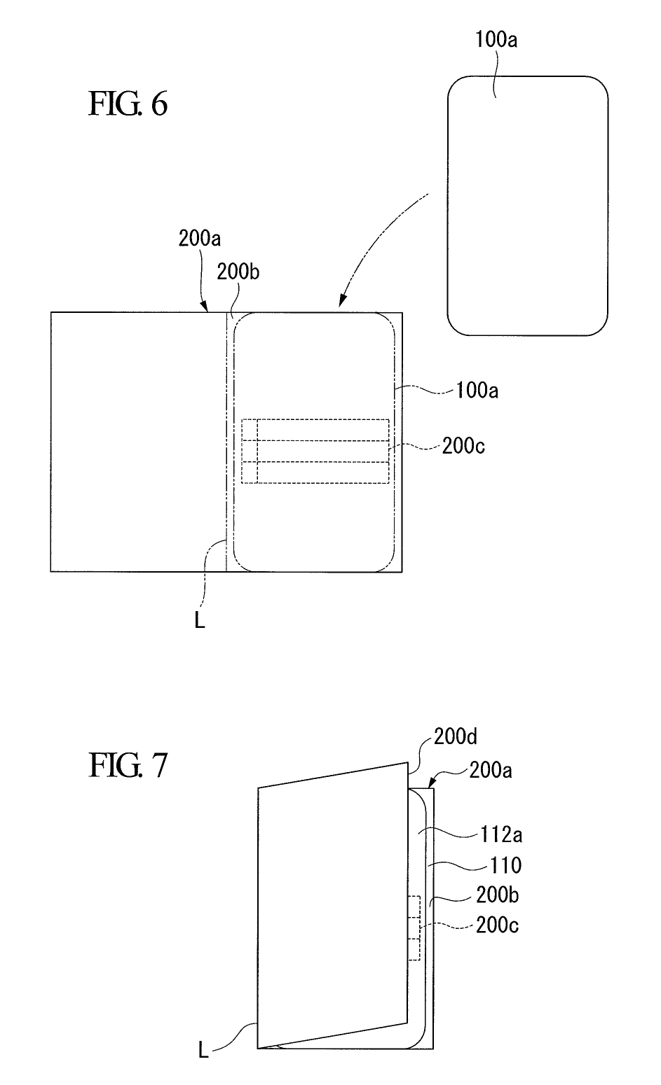

In the example of use, first, a customer as the sender writes a personal information etc. in a box 200c of an inside surface 200b in the base material for a spread postcard 200a. Next, the second release sheet 120b of the double sided adhesive sheet having release sheet 100 is peeled from the second adhesive layer 112b to expose the second adhesive layer 112b. Then, the double sided adhesive sheet having the release sheet 100a in which the first release sheet 120a is not peeled is attached by the exposed second adhesive layer 112b so as to cover the box 200c (see FIG. 6). Next, the first release sheet 120a is peeled from the double sided adhesive sheet 110 to expose the first adhesive layer 112a.

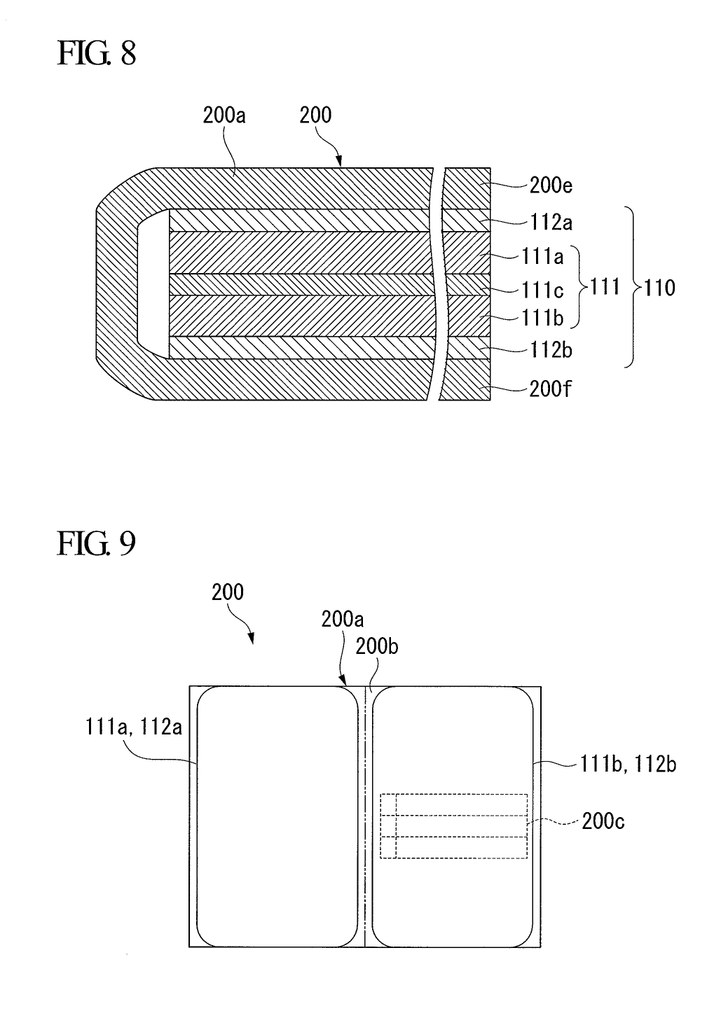

Next, as shown in FIG. 7, the base material for the spread postcard 200a is folded along the return line L and the part 200d of the inside surface 200b, where the double sided adhesive sheet 110 is not attached, is attached to the first adhesive layer 112a. This leads to obtaining, as shown in FIG. 8, the spread postcard 200 which is closed by the double sided adhesive sheet 110 and conceals the personal information etc. In this state, the spread postcard 200 is mailed to a company etc. as the receiver.

On the other hand, the company etc. which receives the spread postcard 200 closed by the double sided adhesive sheet 110 takes the part 200e of the base material for the spread postcard 200a where the first adhesive layer 112a is attached (see FIG. 8) and peels it from the part 200f where the second adhesive layer 112b is attached (see FIG. 8). This leads to the state where the spread postcard 200 is opened by splitting at the inside of the temporary adhesive layer 111c, as shown in FIG. 9. In this state where the spread postcard 200 is opened, the personal information etc. can be read through the second paper base material having light transmission properties 111b and the second adhesive layer 112b. Also, according to need, writing or printing is conducted on the personal information etc.

In the state where the spread postcard 200 is opened, although the temporary adhesive layer which is split at the inside remains on the first paper base material having light transmission properties 111a and the second paper base material having light transmission properties 111b, the temporary adhesive layer remaining on the first paper base material having light transmission properties 111a and the second paper base material having light transmission properties 111b is generally thin and thus hardly has any influence on writing or printing on the personal information etc.

The method for using the double sided adhesive sheet having the release sheet 100 is not limited to the above examples applying the spread postcard folding in two and the double sided adhesive sheet having the release sheet 100 can be applied to the spread postcard folding in three, the spread postcard folding in four etc. Also, the double sided adhesive sheet having the release sheet 100 is not limited to the spread postcard and can be applied to a paper folding in two or more (for example, questionnaire etc.).

In the double sided adhesive sheet having the release sheet 100 of the above embodiment, because the paper base material remains on a spread postcard etc., it is easy to write or print. Especially, it is possible to write or print with aqueous ink and it is easy to print by an ink jet recording method. By using the double sided adhesive sheet having the release sheet, the recycle properties can be ensured. Moreover, because of the paper base material, the breaking property by hand is excellent and thus it is easy to break by hand and dispose.

Also, because the first paper base material having light transmission properties 111a and the second paper base material having light transmission properties 111b are attached by the temporary adhesive layer 111c and the first paper base material having light transmission properties 111a and the second paper base material having light transmission properties 111b cannot be reattached after peeling, if a third person peels the first paper base material having light transmission properties 111a and the second paper base material having light transmission properties 111b from each other, the evidence thereof remains. Therefore, when the double sided adhesive sheet having the release sheet 100 is used in order to close the spread postcard, the fact that the personal information is not seen by a third person can be confirmed by the mailed spread postcard being in the state where the spread postcard remains closed. Also, it is possible to inhibit a third person from unfair opening the spread postcard.

The temporary adhesive layer 111c is formed by the wet laminating method and thus has a stable temporary adhesiveness. Therefore, the release power is stable when opening the spread postcard 200 etc. That is, when opening the spread postcard 200 etc., the temporary adhesive layer 111c is split at the inside, and the adhesiveness of the temporary adhesive layer 111c between the first paper base material having light transmission properties 111a and the second paper base material having light transmission properties 111b hardly has any influence on the release power between the first paper base material having light transmission properties 111a and the second paper base material having light transmission properties 111b.

Also, although release sheets are laminated on both of the first adhesive layer 112a and the second adhesive layer 112b in the above double sided adhesive sheet having the release sheet 100, a release sheet may be only laminating on either the first adhesive layer 112a or the second adhesive layer 112b.

According to a concealing adhesive sheet and concealing adhesive sheet having the release sheet of the present invention, it is easy to write or print on a personal information. Moreover, the temporary adhesiveness between a concealing sheet and a paper base material having light transmission properties as a transparent layer is stable.

Also, according to a double sided adhesive sheet and a double sided adhesive sheet having the release sheet of the present invention, it is easy to write or print on personal information. Also, the recycle properties of a spread postcard etc. can be ensured. Moreover, the temporary adhesiveness between transparent layers is stable.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description but is only limited by the scope of the appended claims.

What is claimed is:

1. A concealing adhesive sheet comprising:
a concealing sheet;
a paper base material having light transmission properties;
a temporary adhesive layer with which the concealing sheet and paper base material having light transmission properties can be peeled from each other and cannot be reattached; and
an adhesive layer provided on the opposite side of the temporary adhesive layer of the paper base material having light transmission properties; wherein
the temporary adhesive layer is formed by a wet laminating method.

2. A concealing adhesive sheet having a release sheet comprising:
the concealing adhesive sheet according to claim 1; and
a release sheet laminated on the adhesive layer of the concealing adhesive sheet.

3. A double sided adhesive sheet comprising:
a temporary adhesive laminated sheet having a pair of paper base materials having light transmission properties, and a temporary adhesive layer by which the pair of paper base materials having light transmission properties can be peeled from each other and cannot be reattached; and
an adhesive layer provided on both sides of the temporary adhesive laminated sheet; wherein
the temporary adhesive layer of the temporary adhesive laminated sheet is formed by a wet laminating method.

4. A double-sided adhesive sheet having a release sheet comprising:
the double sided adhesive sheet according to claim 3; and
a release sheet which is laminated on either one side or both sides of the double sided adhesive sheet.
